(19) United States
(12) Patent Application Publication
(10) Pub. No.: US 2012/0298785 A1
(43) Pub. Date: Nov. 29, 2012

(54) ANTILINE FOULING PLATE FOR DIVE REEL

(76) Inventor: Christopher Lorenzo, Windham, NH (US)

(21) Appl. No.: 13/114,512

(22) Filed: May 24, 2011

(51) Int. Cl. B63C 11/02; B23P 6/00

(52) U.S. Cl. 242/397; 29/402.01

(57) ABSTRACT

A dive reel with an anti-line fouling plate that is secured between a spool assembly and the frame of the dive reel. The anti-line fouling plate prevents the line from becoming trapped or snagged between the spool assembly and frame. The anti-line fouling plate features an outer raised lip and a recessed inner portion, wherein the recessed inner portion is configured to surround the outer diameter of a second side portion of the spool. The anti-line fouling plate can be manufactured with a new reel or can be an additional part configured for and to be added to existing reels. The anti-line fouling plate can be combined with other portions of the dive reel and sold as a replacement part.

### TECHNICAL FIELD

The present invention relates to dive reels used in underwater diving and more particularly, relates to an anti-line fouling plate for a dive reel.

### BACKGROUND INFORMATION

Scuba divers are generally speaking broken down into two basic classes: recreational divers and technical divers. The recreational diver is someone who dives using compressed air or nitrox (up to 40% O₂) as the breathing mix, does not exceed a depth of 130 feet, has a depth and time profile not requiring a decompression stop, can ascend to the surface without stopping if necessary, and does not require specialized training beyond the scope of an open water course. A technical diver is someone who has specialized training beyond that of a recreational diver. This training could include diving beyond the 130 foot limits set for recreational divers. The training could include exceeding depth and time limits of the non-decompression dive tables creating mandatory decompression stops while ascending. The training could include diving with the use of breathing mixtures other than air or using multiple gasses in the course of one dive. In general, the technical diver performs more specialized types of diving such as wreck penetration, ice diving, cavern or cave diving, etc.

Technical divers and some recreational divers use more advanced or specialized equipment. One such piece of specialized equipment would be what is referred to as a dive reel. Dive reels are also know as wreck reels, cave reels, guide reels etc. depending on how they are used. Although dive reels can vary in size, appearance and the materials used in their construction, the basic idea and functionality is fairly universal namely, a reel which contains a length of line that the diver lets out while diving in a cave, shipwreck, area of unclear water or the like and which is used by the diver to find his or her way back to safety or back to a given starting point.

The function of a dive reel is to provide a guide line for a diver or team of divers to be able to find their way back to a given starting point. Guide lines are useful in environments that present conditions such as limited visibility or low light, silting hazards. The use of a guide line is essential when maneuvering inside a wreck, cavern or cave system. In these situations a diver can easily become disoriented and lose his/her way, which can prove to be a fatal mistake for the diver.

A dive reel typically includes a spool that is usually mounted to a frame which in most cases incorporates some sort of handle for gripping. The spool itself usually contains a line which can vary in length, thickness, color, construction and material to meet the needs of the diver and the dive. The reel will usually have some sort of spool tensioning knob or automatic tensioner to prevent or control backlash of the line. The tension knob allows the diver to manually set the tension of the line to their own preference or lock the spool down when not in use. In most cases the dive reel will have some means for the diver to secure the reel to him/herself when not in use such as a snap bolt or clip. Divers will use the snap bolt or clip to attach the reel to a d-ring located on their harness or tanks.

When a diver decides to deploy their dive reel they will attach the end of the line to a secure anchor point, such as a rock or maybe the hand rail of a ship for example. The diver will then swim along, thereby deploying the line contained on the spool. At the point in the dive when the diver decides to turn around they simply turn and begin reeling in the line which in turn returns the diver back to the point where they anchored the line.

One of the problems divers sometimes experience when using a dive reel is “line fouling”. Line fouling can be a significant hazard to a diver or a team of divers. Most times line fouling occurs when the line gets wrapped around the outside of the spool and gets drawn between the spool and the frame. The line will then become tightly wrapped around the axle of the spool rendering the reel inoperable. This happens due to the lack of tight tolerances between the side of the spool and the frame of the dive reel.

In order to attempt to correct this problem, prior art reels have been designed such that the reels may be broken down or taken apart without special tools allowing the diver the chance to remedy the problem underwater. Although the ability to fix the problem underwater is a great idea it is not always something that can be done without costing the diver vital time. Any wasted time could cause a diver to have to follow back up dive plans which in turn could put them into a decompression obligation or could cause them to have to extend decompression times of a plan that already had the diver obligated to decompression stops. Longer time spent in the water also means the diver will need more breathing gas as well. More time in the water also means the potential for exposure to hypothermia. Any of these things and others could ultimately put a diver at great risk for exposure to decompression sickness or even death.

Accordingly, what is needed is a dive reel with a guide line that does not experience line fouling. The dive reel should prevent line fouling and should not require a user to disassemble and reassemble the reel in order to correct line fouling.

### SUMMARY

The present invention features a method of upgrading a dive reel comprising the following acts: removing a spool from an axle of a frame of a dive reel; placing an anti-line fouling plate on the axle, wherein the anti-line fouling plate is disposed between a frame and a spool second side plate, the anti-line fouling plate including a recess into which the spool second side plate is disposed and retained, when assembled, the anti-line fouling plate further including a centrally disposed axial opening for receiving the axle; placing the spool back on the axle; and securing the anti-line fouling plate and the spool to said frame using said axle, thereby creating a tight tolerance between the anti-line fouling plate and the spool second side plate.

Another embodiment of the present invention features a dive reel having an anti-line fouling plate, said dive reel comprising: a frame having a handle, an opening configured to receive a spool of line, and an axle retaining device; a spool having a first side plate, a second side plate, and a hub portion connecting said first and second side plates, said spool having a centrally disposed axle opening, said spool disposable in said frame opening and configured to hold a length of said line; an axle having a first end and a second end, said axle configured to secure the spool to the frame when said first end of said axle is inserted into said central axle opening in said spool and engaged with said axle retaining device disposed on said frame; and an anti-line fouling plate, wherein the anti-line fouling plate is disposed between said frame and said spool second side plate, said anti-line fouling plate including a recess into which said spool second side plate is disposed and retained, when assembled, said anti-line fouling plate further including a centrally disposed axial opening for receiving said axle.

Yet another embodiment of the present invention features a dive reel anti-line fouling plate component for a dive reel comprising: an essentially circular member including an outer raised lip and an inner recessed portion, wherein the inner recessed portion is configured to receive an outer diameter of a first side portion of a spool of a dive reel, wherein the essentially circular member further includes a central opening configured to accept an axle of said dive reel, and wherein the essentially circular member is configured to prevent fouling of a line of the dive reel by preventing the line from passing between the spool and a frame of the dive reel.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1. is an assembled, left side perspective view of a dive reel with anti-line fouling plate according to the present invention;

FIG. 2 is an assembled, right side perspective view of a dive reel with anti-line fouling plate according to the present invention;

FIG. 3 is a disassembled front perspective view of a dive reel with anti-line fouling plate according to the invention shown; and

FIG. 4 is a disassembled rear perspective view of a dive reel with anti-line fouling plate according to the invention.

### DETAILED DESCRIPTION OF THE PREFERRED EMBODIMENTS

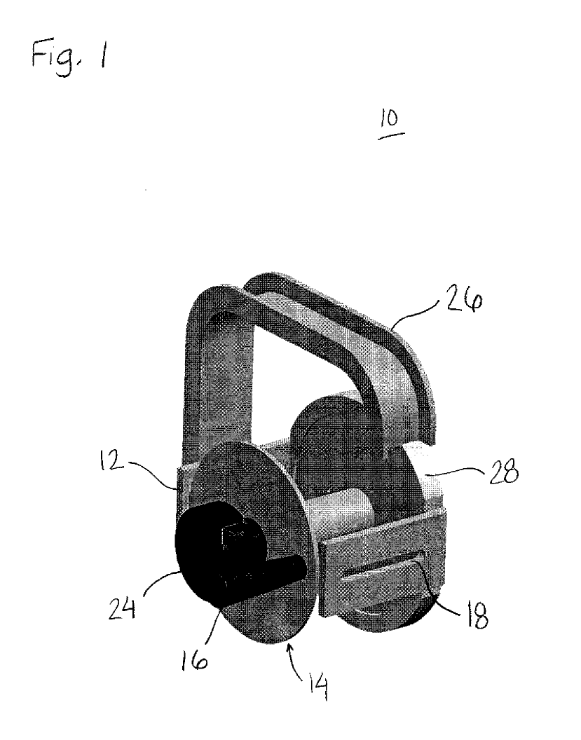

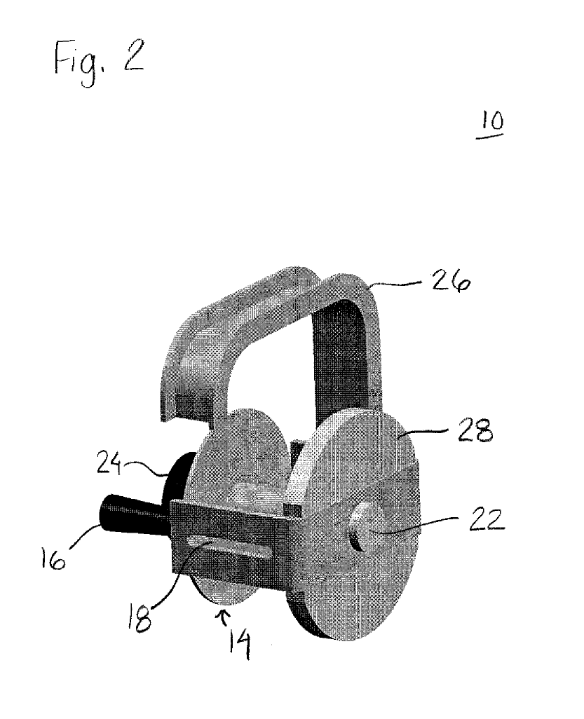

A representative dive reel 10, FIGS. 1-4, on which the present anti-line fouling plate may be used, includes a frame 12 that is configured to hold a spool assembly 14. The spool assembly includes a first side portion 34, a second side portion 36 and a central hub portion 44. The spool assembly 14 is configured to be wound with a line or rope (not shown). The size of the spool assembly 14 is generally proportional to the amount of line that the spool assembly 14 will hold. The line exits the frame 12 of the dive reel 10 through an opening or slot 18. An axle 20 runs through a central axis 42 of the central hub portion 44 of the spool assembly 14 and is configured to secure the spool assembly 14 in position. The axle 20 is secured to the frame 12 by an axle receiving device, such as a nut 22, secured to the frame 12 at one end, and by a knob 24 at an opposite end that pushes against the second side portion 36 of the spool assembly 14. The knob 24 and axle 20 work in conjunction with one another to adjust tension on the spool assembly 14 and prevent free wheeling of the spool assembly 14. The knob 24 is located on a second side portion 36 of the spool assembly 14. The frame 12 may also feature a handle 26. The handle 26 is the portion of the dive reel 10 that is gripped by a user. The dive reel 10 may also feature a protruding member 16, located on the second side portion 36 of the spool assembly 14, which aids in the rotation of the spool assembly 14.

The dive reel 10 is shown with an anti-line fouling plate 28 in accordance with the present invention. The anti-line fouling plate 28 features an outer raised lip 30 and a recessed inner portion or pocket 32. The pocket 32 is sized and configured to receive a first side portion 34 of the spool assembly 14. The tight tolerance around outer diameter 38 of the first side portion 34 of the spool assembly 14, combined with the depth of the pocket created by the recessed inner portion 32, prevents the line wound on the spool from being able to enter or be dragged between a gap that previously existed and was created between the first side portion 34 of the spool assembly 14 and the frame 12 of the dive reel 10. The depth of the recessed inner portion 32 prevents the outer diameter (or edge) 38 of the first side portion 34 of the spool from being exposed, thereby eliminating the chance for the line to get caught between the spool assembly 14 and the frame 12. The axle 20 secures the anti-line fouling plate 28, which also features a central axis 42 to the spool assembly 14.

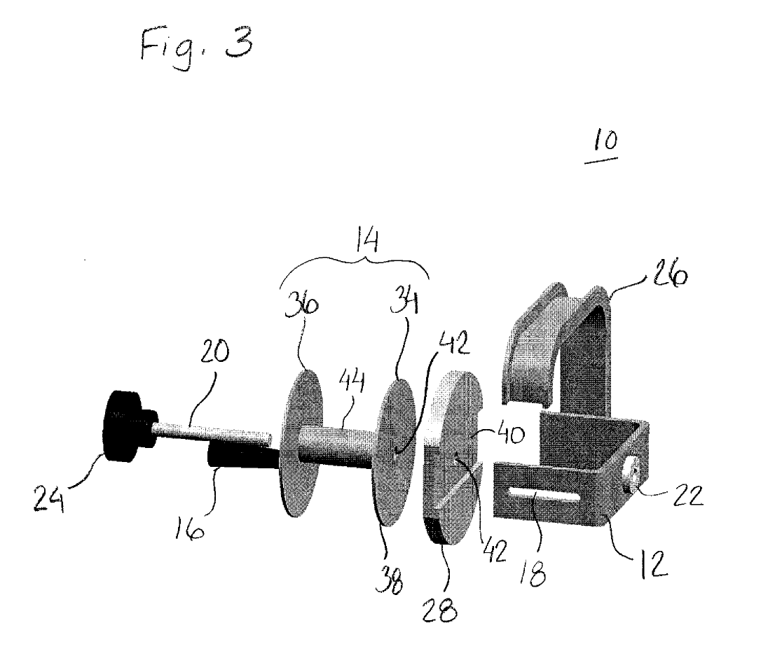

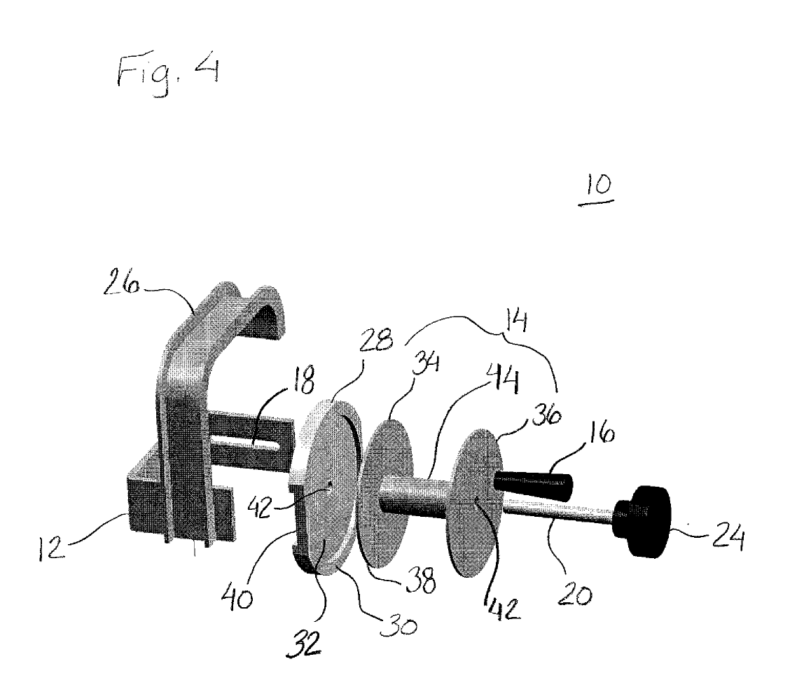

The anti-line fouling plate 28 can be made from any material that can be machined or molded, such as plastic, steel, aluminum, stainless steel or titanium. In a preferred embodiment, the anti-line fouling plate 28 is constructed from Delrin®. Delrin® is a preferable material for manufacturing because it exhibits good machining characteristics and mechanical properties, as well as being virtually unaffected by the harsh environment of the ocean while also essentially eliminating any friction between anti-line fouling plate and the side portion 34 of the dive reel. For the reel design with the frame shown in FIGS. 3-4, the anti-line fouling plate 28 may feature one or more indentations or recessions 40 that are configured to allow the anti-line fouling plate 28 to tightly attach to the frame 12. Examples of an indentation or slot 40 can be seen in FIGS. 3 and 4. It is contemplated and within the scope of the current application that the reel design and frame, as well as the method of fastening the anti-line fouling plate to the frame may be employed in a different way from that described herein, depending on the design of a given dive reel to which the anti-line fouling plate is adapted.

In a first embodiment, the anti-line fouling plate 28 is manufactured and sold with the dive reel 10. In another embodiment, it is contemplated that that the anti-line fouling plate 28 could be utilized with an existing or already manufactured dive reel 10 in order to modify the dive reel 10 to prevent line fouling. In this embodiment, the anti-line fouling plate 28 may be designed as a singular replacement part that a user could add to a dive reel 10 that a diver already owns. A longer shaft 20 with or without a knob 24 may be required. It is also contemplated that the anti-line fouling plate 28 may be sold as part of a multiple component replacement part. For example, the anti-line fouling plate 28 may be combined with a handle 26 and sold as replacement part for the current handle on a dive reel. Adapting the anti-line fouling plate 28 into an existing or newly manufactured reel will vary based on application and design of the existing dive reel.

Accordingly, the present invention provides an anti-line fouling plate that is configured to be placed between the spool and the frame of a dive reel to prevent fouling of the line between the spool and the frame. The present invention is shown in use with one particular frame design, however it is contemplated and within the scope of the current invention that the invention can be used with any dive reel frame design.

Modifications and substitutions by one of ordinary skill in the art are considered to be within the scope of the present invention, which is not to be limited except by the following claims.

1. A dive reel having an anti-line fouling plate, said dive reel comprising:
a frame, said frame having a handle, an opening configured to receive a spool assembly, and an axle retaining device disposed on said frame, the spool assembly having a first side plate, a second side plate, and a hub portion connecting said first and second side plates, said spool assembly having a centrally disposed axle opening extending through said first and second side plates and said hub, said spool assembly disposable in said frame opening and configured to hold a length of said line;
an axle having a first end and a second end, said axle configured to secure the spool assembly to the frame when said first end of said axle is inserted into said central axle opening in said spool assembly and engaged with said axle retaining device disposed on said frame; and
an anti-line fouling plate, wherein the anti-line fouling plate is disposed between said frame and said spool second side plate, said anti-line fouling plate including a recess into which said spool second side plate is disposed and retained when assembled, said anti-line fouling plate further including a centrally disposed axial opening, for receiving said axle.

2. A method of upgrading a dive reel with an anti-line fouling plate, the dive reel comprising a frame, said frame having an opening configured to receive a spool assembly, and an axle retaining device disposed on said frame, the spool assembly having a first side plate, a second side plate, and a hub portion connecting said first and second side plates, said spool assembly having a centrally disposed axle opening extending through said first and second side plates and said hub, said spool assembly disposable in said frame opening and configured to hold a length of said line, an axle having a first end and a second end, said axle configured to secure the spool assembly to the frame when said first end of said axle is inserted into said central axle opening in said spool assembly and engaged with said axle retaining device disposed on said frame, said method of upgrading a dive reel with an anti-line fouling plate comprising the acts of:
removing said spool assembly from said opening in said frame;
placing an anti-line fouling plate on the axle, wherein the anti-line fouling plate is disposed between said frame and said spool assembly second side plate, said anti-line fouling plate including a recess into which said spool assembly second side plate is disposed and retained, when assembled, said anti-line fouling plate further including a centrally disposed axial opening for receiving said axle;
placing the spool assembly back on the axle; and
securing the anti-line fouling plate and the spool assembly to said frame using said axle.

3. A dive reel anti-line fouling plate component for a dive reel, the dive reel comprising a frame, said frame having an opening configured to receive a spool assembly, and an axle retaining device disposed on said frame, the spool assembly having a first side plate, a second side plate, and a hub portion connecting said first and second side plates, said spool assembly having a centrally disposed axle opening extending through said first and second side plates and said hub, said spool assembly disposable in said frame opening and configured to hold a length of said line, an axle having a first end and a second end, said axle configured to secure the spool assembly to the frame when said first end of said axle is inserted into said central axle opening in said spool assembly and engaged with said axle retaining device disposed on said frame, said anti-line fouling plate component comprising:
an essentially circular member including an outer raised lip created by an inner recessed portion, wherein the inner recessed portion is configured to receive an outer diameter of a second side portion of said dive reel spool assembly, wherein the essentially circular member further includes a central opening configured to accept an axle of said dive reel, and wherein the essentially circular member is configured to prevent fouling of a line of the dive reel by preventing the line from passing between the spool assembly and the frame of the dive reel.
